(19) United States
(12) Patent Application Publication
(10) Pub. No.: US 2015/0123354 A1
(43) Pub. Date: May 7, 2015

(54) SEALING SURFACE, IN PARTICULAR FOR A VACUUM CHAMBER OF A MASS SPECTROMETER AND METHOD OF MANUFACTURING SUCH A SEALING SURFACE

(71) Applicant: VACUTEC Hochvakuum- & Präzisionstechnik GmbH, Bremen (DE)

(72) Inventors: Carsten LASER, Weyhe (DE); Bernd LASER, Weyhe (DE)

(73) Assignee: VACUTEC Hochvakuum- & Präzisionstechnik GmbH, Bremen (DE)

(21) Appl. No.: 14/529,560

(22) Filed: Oct. 31, 2014

(30) Foreign Application Priority Data
Nov. 1, 2013 (DE) 10 2013 112 070.9

(51) Int. Cl. F16J 15/08; B26F 1/26; B23H 9/00; B23K 26/36

(52) U.S. Cl. CPC F16J 15/0806; B23K 26/367; B26F 1/26; B23H 9/001
USPC 277/648; 219/69.17; 219/121.69; 83/53

(57) ABSTRACT

A sealing surface, in particular for a vacuum chamber of a mass spectrometer and an associated manufacturing process, has non-circular shapes and can be produced with low effort. The sealing surface has circumferential cracks, being produced by erosion or jet machining or indentation-forming. A method manufactures such a sealing surface, a component has such a sealing surface, a vacuum chamber is made of components with such sealing surfaces and a mass spectrometer has such a vacuum chamber. In the prior art annular sealing surfaces are produced by turning. Milling permits a non-annular embodiment but is disadvantageous in case of sealing.

### CROSS REFERENCE TO RELATED APPLICATIONS

Applicant claims priority under 35 U.S.C. §119 of German Application No. 10 2013 112 070.9 filed Nov. 1, 2013, the disclosure of which is incorporated by reference.

### BACKGROUND OF THE INVENTION

1. Field of the Invention

The invention relates to a sealing surface, in particular for a vacuum chamber, a method of manufacturing such a sealing surface, a component with such a sealing surface, a vacuum chamber as well as a mass spectrometer with such a vacuum chamber.

2. Description of the Related Art

For high or ultra high vacuum components the use of flanges with turned sealing surfaces, so-called “Conflat flanges” (CF flanges), is known. Thereby, the sealing surfaces have circular concentric grooves. Metal rings or gaskets are preferably used as a seal between two sealing surfaces, whereby the metal rings or gaskets fill up the grooves of the sealing surfaces and thereby provide a reliable seal. The gaskets used are usually made of copper or aluminum. In contrast to rubber seals, the advantage of a metal seal is that it does not outgas. In particular, when used in a mass spectrometer outgassing can interfere with the analysis and distort measurement results.

The above-mentioned grooves are produced by the manufacturing process of turning. This results in a rotationally symmetrical arrangement of the sealing surfaces, which are thus formed annular. However, this machining process for sealing surfaces is disadvantageous because no non-annular sealing surfaces can be produced. Thus, for example, no square-like sealing surfaces are possible. The use of square-like sealing surfaces, however, would make the handling of the vacuum chamber, in particular during insertion of components, for example multipoles, easier and would overall improve it. Thus, for example, instead of a round opening at the base or top surface of a cylindrical vacuum chamber an angular cylinder shape can be used for the vacuum chamber, which is open on one longitudinal side. Thus, the component or the multipole could be inserted from the longitudinal side of the vacuum chamber and has not to be pushed into the round opening of the base or top surface.

Non-annular sealing surfaces can be indeed produced by milling. When milling, however, very small channels are formed, which run across the sealing surface from the inside to the outside. This can lead to leaks, which can be particularly disadvantageous to high and ultra high vacuum components.

### SUMMARY OF THE INVENTION

It is thus the object of the invention to provide a sealing surface, which can also be formed as a non-circular or rather as a non-annular shape and can be produced with low effort.

The invention solves the object by a sealing surface, which has circumferential cracks. These cracks are produced by the manufacturing processes of erosion, jet machining or indentation-forming. In measurement technique, especially in the classification of shape deviations according to DIN 4760, the surface textures are categorized. The third order of the shape deviation is represented by grooves and the fourth order by cracks. Cracks have overall smaller shape deviations as grooves. The roughness of a surface is determined by grooves and cracks. The roughness can be defined, for example, by the width of the groove or the crack and by the depth of the groove or the crack. In summary, cracks are identified as fine grooves on a surface, representing in particular a group of fine, grooves-shaped indentations.

The cracks are arranged circumferentially on the sealing surface. This means in particular that the cracks run around the opening in the sealing surface, thereby circling it at least once. The manufacturing process of jet machining is a subgroup of the category “cutting with geometrically non-defined tool angles”. With jet machining all manufacturing processes are meant, in which the machining effect is caused by a high pressure jet. This high pressure jet can be provided with abrasive additives, especially if the manufacturing structures have to be very fine. The manufacturing process of erosion names the non-mechanical removal of material parts. The erosion can be divided into thermal, chemical and electrochemical erosion. The manufacturing process “indentation-forming” is subordinated to the category “forming”. Therefore, the indentation-forming takes place with retention of mass and material context.

Because of the circumferential cracks the high requirements on a sealing surface, in particular for a vacuum chamber are met. Due to the circulation of the cracks the resulting channels are arranged parallel to the outer side of the sealing surface, which provides a high sealing effect. Because of the chosen manufacturing processes of erosion or jet machining non-annular sealing surfaces can advantageously be provided with cracks.

In a preferred embodiment, the cracks are formed concentrically or spirally. In particular, the concentric or spiral shape is non-circular. Thus, the cracks can be formed as a plurality of nested rectangles or angular shaped spirals. Concentric cracks have the advantage that the beginning and end of the cracks is closed. Therefore, no gap is created, which could compromise the effectiveness of the sealing surface. In contrast, a spiral embodiment has the advantage that the tool used forming the cracks has not to be stopped so that a continuous indentation is formed.

In a preferred embodiment, the cracks are made via laser cutting, etching, water jet cutting or electro discharge machining. Laser cutting, etching and electro discharge machining are part of the manufacturing process of erosion while the water jet cutting belongs to the category of jet machining. With all of the listed manufacturing processes very fine structures in the range of 1 micron to 1 mm can be produced. In the process of water jet cutting the micro water jet cutting is preferably used. Particularly preferred is laser cutting to produce the cracks. With laser cutting predominantly rework-free components are produced.

When the method of electro discharge machining is used to form concentric cracks, comb-like electrode tips can be used. This permits simultaneous embodiment of the cracks, resulting in saving of time. The distance between the electrode tips to each other determines the distance of the cracks and can be adjusted.

Alternatively, the cracks are pushed in by using, for example, a center punch. Pushing in means in this context not a punctual indentation-forming with vertical pressure on the workpiece but a punctual indentation-forming with vertical pressure by simultaneously pulling the tool on the workpiece along a line so that the cracks are formed. In another alternative, the erasing, which belongs to the graphical printing process, can be used, whereby the normally following part of the process regarding the printing technology is omitted. Preferably, a pointed tool is used in the process to score the cracks into the sealing surface. For example, such a tool can be a thorn, a stylus, a scriber, an etching needle or another needle. Most preferably, the tip of the tool is covered with diamonds or diamond fragments, or the diamond fragments are edged into the tool. Alternatively, when using such tools swarf can arise so that the process can be attributed to the micro machining.

When machining steel with diamond tools, the tools suffer from high wear due to chemical reactions. Prior to the machining, the workpiece is therefore preferably subjected to a thermochemical surface layer treatment so that the wear of the diamonds is highly reduced.

In a preferred embodiment, the sealing surface has a predetermined roughness because of the cracks. The roughness can be defined and adjusted by, for example, the groove depth and the groove width. In particular, the roughness is adjusted by the application method of the used process. Depending on how the used tool is adjusted, different structures of the cracks and thus a different roughness results. In laser cutting, for example, the laser beam can have, for example, a different diameter and/or a different energy, which leads to different depths and widths of the cracks.

In a preferred embodiment, the sealing surface is shaped non-circular. Particularly, the sealing surface is preferred angular, in particular rectangular and has thereby rounded edges. Analog to the shape of the sealing surface, the cracks are non-circular in the preferred embodiment. More preferably, they are adjusted to the shape of the sealing surface and are therefore particularly preferred angular, in particular rectangular and circumferential with rounded edges. An angular embodiment of the sealing surface and thus of the cracks simplifies the handling during insertion and removal of a component—such as a multipole—in or out of the vacuum chamber. For example, the vacuum chamber thereby can be rectangular cylindrical in outer shape, whereby the one side of the chamber, which is formed as a lid, can be screwed from above onto the body of the chamber. The connection thereby is, for example, a flange connection.

In a preferred embodiment, the sealing surface is made from metal. Particularly preferred, a metal seal is used as a seal. Due to not using rubber or rubber-like material no outgassing can occur, which could adversely affect the measurement analysis.

In an additionally preferred embodiment, the sealing surface can be arranged obliquely. Preferred in this context is that either the side facing the opening or the side facing the flange surface is lower than the respective opposite side. This permits the seal, for example a sealing ring—while joining the two flange surfaces—from slipping and the seal can perfectly adapt to pressure in such a way that a very good sealing is developed.

In a further preferred embodiment, the shape of the cracks is variable in its cross-section. The cross-sectional shape is inter alia determined by the tool used to form the cracks. While cracks formed by a laser have preferably a cross-section with a rounded shape, rectangular cross-sections can be provided, for example, by means of etching. By using die-sinking almost any shape can be created, depending on how the used negative mold is formed.

The invention also relates to a component having such a sealing surface. A component can be, for example, the body of a volume chamber or the lid of a volume chamber. Preferably, the component is formed in such a way that it has bores for flanging a further component. In addition, the invention relates to a vacuum chamber having at least two components. Preference is given to an inner space sealed by joining the two components from the environment. More preferably, the two components are formed as a body of a vacuum chamber and as a lid of a vacuum chamber, which can in particular be connected to one another by flanges. Thereby, the body of the vacuum chamber contains the inner space, which is to be sealed. The invention further relates to a mass spectrometer having a vacuum chamber according to the invention, which can be sealed with a sealing surface according to the invention.

### BRIEF DESCRIPTION OF THE DRAWINGS

Further advantageous embodiments are evident from the dependent claims and from the in detail explained embodiments out of the accompanying drawings. The drawings are showing:

FIG. 1 shows a top view of a flange surface according to a first embodiment of the invention,

FIG. 2 shows a top view of a flange surface according to a second embodiment of the invention and

FIGS. 3 to 5 show side views of a sealing surface according to the invention with several alternate embodiments, which can be combined with the first and second embodiments of the invention.

### DETAILED DESCRIPTION OF PREFERRED EMBODIMENTS

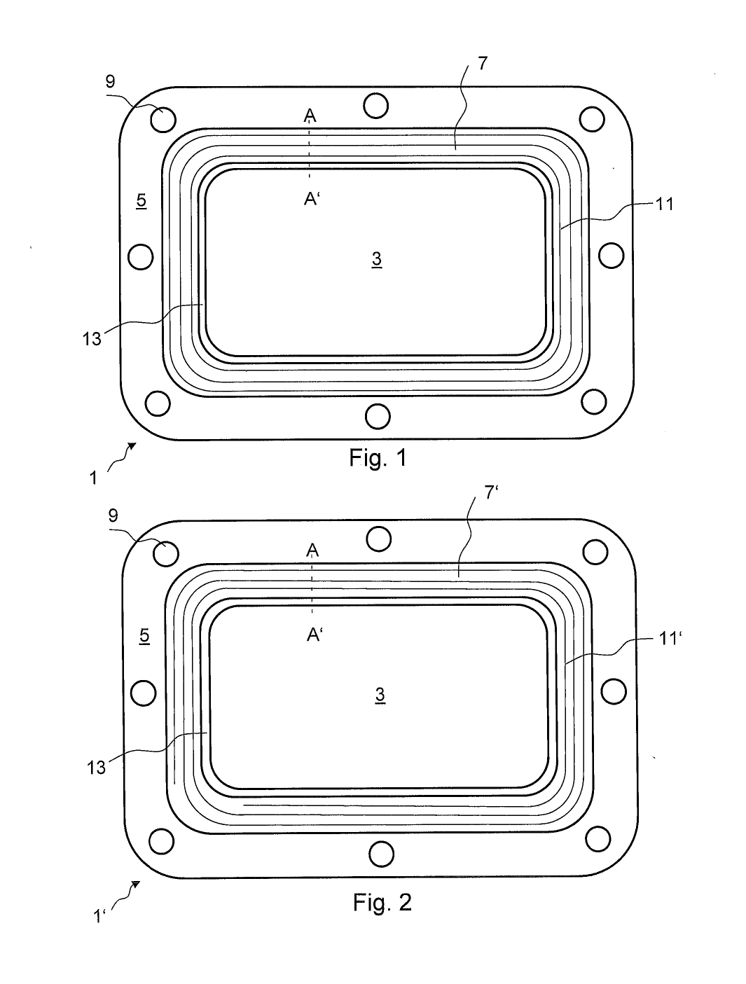

FIG. 1 shows a flange surface 1 in top view. The flange surface 1 belongs to the body of a vacuum chamber, which extends into the image (away from the viewer). In the center of the flange surface 1 there is the opening 3 to the inner space of the vacuum chamber. The flange surface 1 also has a screw surface 5 and a sealing surface 7. The screw surface 5 is arranged on the outer edge of flange surface 1 and has bores 9. By means of these bores 9, it is possible to connect the flange surface 1 to another flange surface by screwing. The sealing surface 7 is arranged between the screw surface 5 and the opening 3 and has concentric circular cracks 11. The number of circumferential cracks can be variably selected, depending on the purpose. In the opening 3, a step 13 is arranged.

In the embodiment of FIG. 1 the flange surface 1 is shown rectangular in shape. The body of the vacuum chamber is therefore also preferably shaped rectangular. The edges of the flange surface—and thus the outer edges of the vacuum chamber,—the edges of the screw surface 5, of the sealing surface 7 and of the opening 3 are rounded. This is advantageous because in edges or at edges high internal stress can occur in the material, which could damage the component at these spots. Rounded edges, however, counteract stress concentration at certain spots so that lower maximum material stress occurs.

FIG. 2 shows a flange surface 1′ with a sealing surface 7′. The sealing surface 7′ has cracks 11′, which run spirally on the sealing surface 7′. Thereby, the spiral shape of the cracks 11′ is formed angular. However, again all edges are formed rounded to avoid a concentration of stress on a single spot. The spiral arrangement of the cracks 11′ has the advantage that during making the cracks 11′ the tool has not to be stopped after executing a circle. Thus, for example, a laser beam can be directed spirally from the outside inwards or from the inside outwards on the sealing surface in accordance with the shape of the sealing surface.

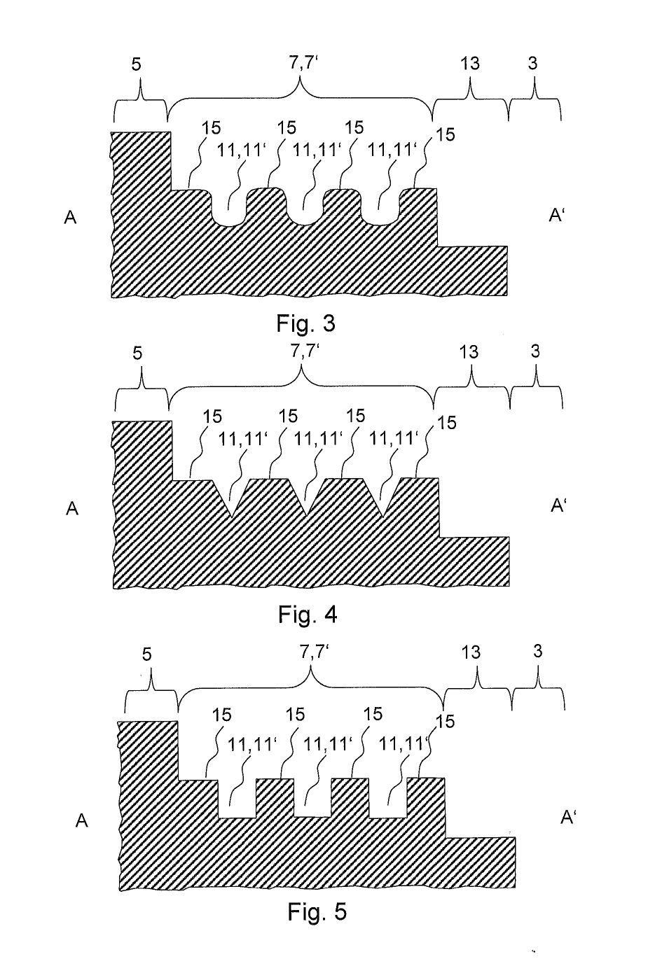

The outer shape of the flange surface 1 and 1′ in FIGS. 1 and 2 is not limited to the rectangular shape. In particular, the flange surfaces 1 and 1′, the screw surface 5, the opening 3 and the sealing surfaces 7 and 7′ can have all shapes, which are not circular. For example, one possibility is a square shape or an oval shape. The cross-section of the sealing surface 7, 7′ is formed in a way, depending on the used tool or its adjustment and can, for example, have the shapes shown in FIGS. 3 to 5.

FIG. 3 shows a side view or a cross-section of the sealing surface 7, 7′ through the profile A-A′ in FIG. 1 or 2. The sealing surface 7, 7′ can be thereby formed as shown in FIG. 3. The cracks 11, 11′ running parallel to one another are rounded so that they extend in the shape of an arc into the surface 15 of the sealing surface 7, 7′. The embodiment of the cracks is thereby determined by the choice and the application method of the manufacturing process. The shape shown in FIG. 3 can be produced, for example, by laser cutting.

Towards the outside of the vacuum chamber the sealing surface 7, 7′ is adjacent to the screw surface 5. To the other side, namely towards the opening 3, the sealing surface 7, 7′ is, however, adjacent to the step 13. The step 13 is thus arranged between the sealing surface 7, 7′ and the opening 3.

FIG. 4 shows the sealing surface 7, 7′ with an alternate embodiment of the cracks 11, 11′ in side view. The cracks are formed pointed so that they extend in the shape of a triangle into the surface 15 of the sealing surface 7, 7′. Such a shape can, for example, be produced by die-sinking. Putting a seal on the sealing surface 7, 7′ in FIG. 3 or 4, the seal, which consists in particular of metal, is pressed into the cracks 11, 11′ so that the cracks 11, 11′ are filled with the material of the seal. Thus, the vacuum chamber is closed by means of the sealing surfaces 7, 7′.

FIG. 5 shows a further alternate embodiment of the cross-section of the cracks 11, 11′. Those are placed as rectangular-like indentations in the surface 15 of the sealing surface 7, 7′. This shape can, for example, be produced by etching or electro discharge machining.

The embodiments shown in FIGS. 3, 4 and 5 referring to the embodiment of the cracks 11, 11′ can be optionally combined with the embodiment of the cracks shown in FIGS. 1 and 2. Thus, the cracks can, for example, be spirally shaped and can extend in a rectangular shape into the surface 15. Alternatively, they run, for example, spirally or concentrically with a triangular indentation. Moreover, the shapes of the indentation are not limited to the embodiments shown in the figures.

All features mentioned in the above description and in the claims are individually and in optional combination combinable with the features of the independent claims. The disclosure of the invention is thus not limited to the described or claimed feature combinations. In fact, all reasonable combinations of features are disclosed in the scope of the present invention.

What is claimed is:

1. Sealing surface, in particular for a vacuum chamber, wherein the sealing surface (7, 7′) has circumferential cracks (11, 11′), which are produced by means of erosion, jet machining or indentation-forming.

2. Sealing surface according to claim 1, wherein the cracks (11, 11′) are formed concentrically or spirally.

3. Sealing surface according to claim 1, wherein the cracks (11, 11′) are produced by laser cutting, etching, water jet cutting or electro discharge machining.

4. Sealing surface according to claim 1, wherein the sealing surface (7, 7′) has a predetermined roughness due to the cracks (11, 11′).

5. Sealing surface according to claim 1, wherein the sealing surface (7, 7′) and the cracks (11, 11′) are non-circular and in particular have rounded edges.

6. Sealing surface according to claim 1, wherein the sealing surface (7, 7′) is made from metal.

7. Method of manufacturing a sealing surface (7, 7′), in particular for a vacuum chamber, comprising manufacturing of circumferential cracks (11, 11′) in the sealing surface by means of erosion, jet machining or indentation-forming.

8. Method of manufacturing according to claim 7, wherein the cracks (11, 11′) are formed concentrically or spirally.

9. Method of manufacturing according to claim 7, comprising manufacturing of the cracks (11, 11′) by means of laser cutting, etching, water jet cutting or electro discharge machining.

10. Method of manufacturing according to claim 7, comprising adjusting the predetermined roughness of the sealing surface (7, 7′) due to the cracks (11, 11′).

11. Method of manufacturing according to claim 7, wherein the sealing surface (7, 7′) and the cracks (11, 11′) are formed non-circular, in particular formed in such a way that they have rounded edges.

12. Method of manufacturing according to claim 7, wherein the sealing surface (7, 7′) is made from metal.

13. Component having a sealing surface (7, 7′) according to claim 1.

14. Vacuum chamber with at least two components according to claim 13, which is sealed by means of the seals by joining the two components.

15. Mass spectrometer having a vacuum chamber according to claim 14.
